(19) United States
(12) Patent Application Publication
(10) Pub. No.: US 2025/0018754 A1
(43) Pub. Date: Jan. 16, 2025

(54) Modular Trailer Coupling Lock

(71) Applicant: Altor Locks, LLC, Sterling, VA (US)

(72) Inventor: Dylan Cato, Sterling, VA (US)

(21) Appl. No.: 18/771,942

(22) Filed: Jul. 12, 2024

Related U.S. Application Data
(63) Continuation-in-part of application No. 63/526,398, filed on Jul. 12, 2023.

(51) Int. Cl. B60D 1/60; B60D 1/06; B60D 1/28

(52) U.S. Cl. CPC B60D 1/60; B60D 1/06; B60D 1/28

(57) ABSTRACT

A modular locking assembly having a universal cavity and adapters for a predetermined type of trailer hitch coupling that adapt the locking assembly to a wide variety of trailer hitch couplers without having to manufacture and stock a different SKU for the most expensive component of the lock.

### FIELD OF THE INVENTION

The invention relates to trailer coupling locks that have a modular construction. The modular construction allows for the use of any of various adapters that allow the lock to be used with trailer couplers having different types of construction. The locks of the present invention are particularly designed for towed devices having residential or light commercial use.

### BACKGROUND OF THE INVENTION

The trailer coupler is a key connector between: (a) a towed device, which is generally referred to herein as “a trailer” that is a device to carry something else (e.g., a boat, secured motorcycle, or load of mulch) or a mobile home, and (b) the towing vehicle (e.g., a pickup truck, sports utility vehicle, or automobile that have been fitted with a hitch of some type). The use of a ball hitch in one of several sizes is common in the US so straight, A-frame, and channel ball hitch couplers on the towed device are also commonly seen.

But a ball hitch is not the only type of coupler on the market. For example, a sleeve lock coupler is also available in straight, channel, or A-frame styles. See https://bit.ly/3OaHmF3.

Trailers that use a ball hitch (bumper pull) have many different types of couplers. Between towable RV's, industrial trailers, and boat trailers there are over 30 different types. This is a problem when trying to lock and secure the coupler because there is no trailer lock that fits every coupler securely.

The wide variety of coupler types is a challenge for trailer lock manufacturers as well as consumers and retailers. Manufacturing a specific lock for each type of trailer coupler is prohibitively expensive as each different design requires significant design resources, unique tooling, investment in inventory, etc. The different designs confuse consumers and trailer lock retailers because they each need to figure out which particular lock they need for a specific coupler.

It would be desirable to have a modular trailer coupling lock system that could accommodate a variety of different coupler types.

### SUMMARY OF THE INVENTION

It is an objective of the invention to provide a universal trailer coupler lock that can be used with one or more adapters to securely lock a wide variety of trailer coupling configurations.

In accordance with this and other objectives of the invention that will become apparent from the description herein, the invention is a trailer hitch lock that secures a trailer hitch receiver coupling to a trailer hitch, said lock comprising: (a) a lock assembly with a cavity that at least partially or, optionally, fully covers the trailer hitch receiver coupling when said assembly is in a locked position; (b) an adapter shaped to fit into said cavity to make the lock fit a predetermined couplers in a secure manner against unintended decoupling.

The present invention provides a universal coupling lock (the relatively expensive component) that can be manufactured in volume while a series of relatively less expensive adapters are provided that fit within the universal lock to adapt it for secure use with a wide variety of trailer coupling configurations. This configuration reduces the costs for the manufacturer, the retailer, and the consumer due to the economies of scale while also making it possible to provide a highly secure coupling lock for a much wider variety of hitch coupling configurations.

### BRIEF DESCRIPTION OF THE DRAWINGS

FIG. 1 is a sectional view of a trailer coupler and universal lock assembly having an L-shaped adapter within the universal cavity to adapt the universal cavity to fit a ball hitch coupler.

FIG. 2 is a sectional view of the trailer coupler of FIG. 1 with greater details for the lock body assembly.

FIG. 3 is like the coupler lock assembly of FIG. 1 but with a lock body having an extension portion of reduced size to fit within the coupler.

FIGS. 4 and 5 show side-by-side views of a lock body assembly having a reduced extension portion (FIG. 4) and a full-sized extension portion (FIG. 5).

FIG. 6 shows a conventional A-frame sleeve lock coupler with a universal lock according to the invention having a series of external fins to deter attacks by angle grinders. See PCT/US2021/039605 US Publication No. 2023/0143140, the disclosures of which are hereby incorporated by reference.

FIG. 7 is an illustration showing a partial view of the universal cavity and a bottom adapter therein.

FIG. 8 shows an adapter having a concave central region.

FIG. 9 shows a bent adapter having a generally L-shape.

FIGS. 10-12 show other types of adapter insert to fit other hitch coupler configurations.

FIG. 13 shows a flat bottom adapter as depicted in FIG. 7.

FIG. 14 shows a flat adapter having a centrally-located through-hole.

FIGS. 15-19 depict different types of prior art trailer couplers.

FIGS. 20-22 illustrate the addition of sub-adapter plates of various thicknesses to a main adapter, such as that of FIG. 9, for enhanced fit on additional couplers.

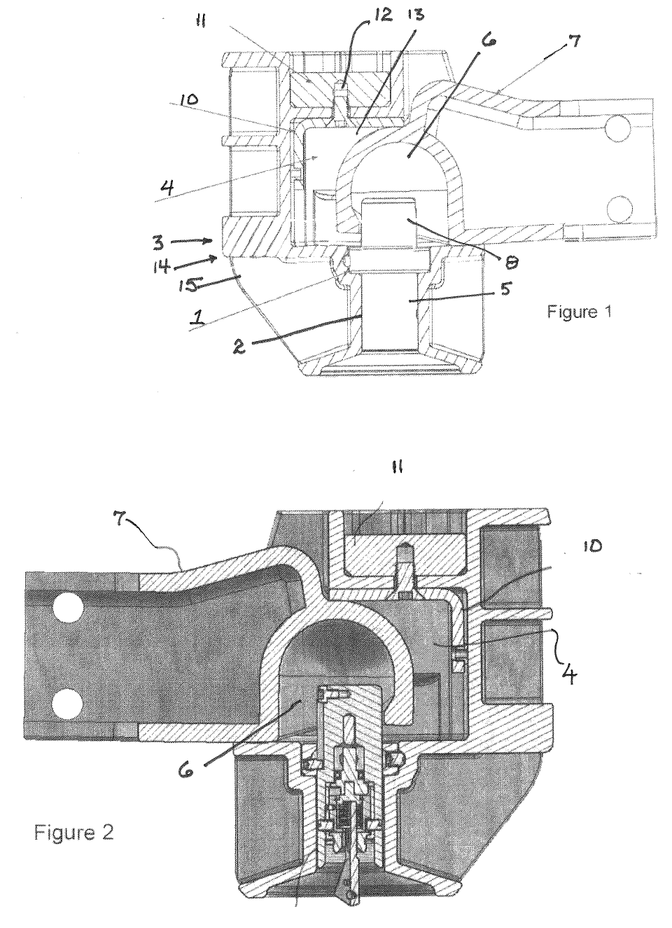

### DETAILED DESCRIPTION OF THE INVENTION

All trailer coupler locks, except U-lock based designs, have slot or cavity that covers the trailer coupler so that a ball hitch cannot be connected to the trailer coupler.

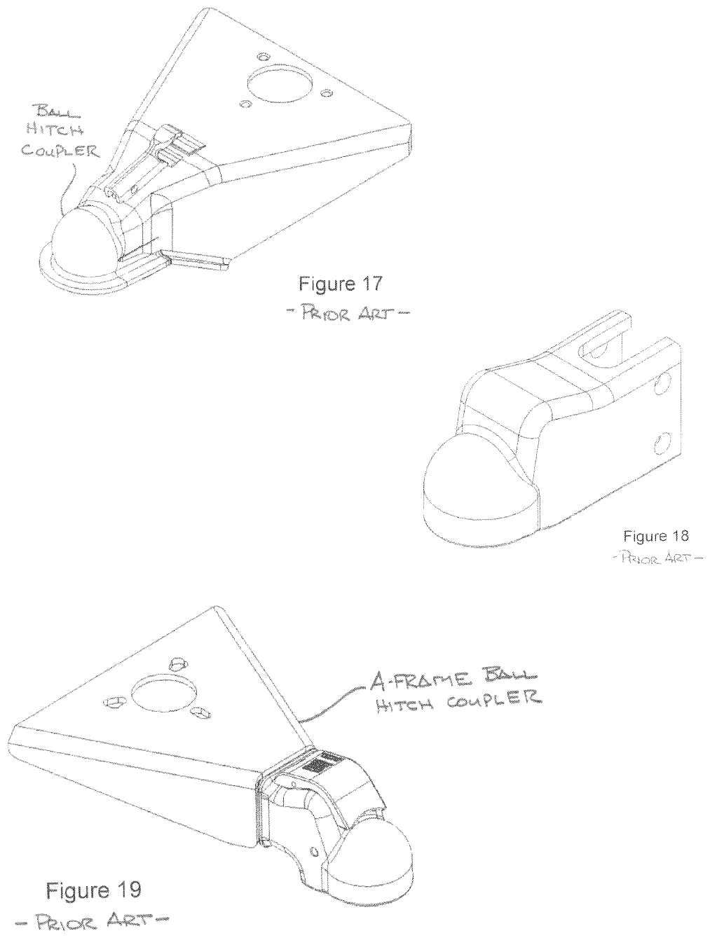

The present invention uses a solid adapter to configure a trailer coupler lock having a universal cavity for each of a variety of different trailer couplings. (See FIGS. 16-19 for examples of typical prior art couplers of differing configuration that can be locked with the present invention.) Each adapter fits into the universal cavity in such a manner that it will make a trailer coupler secure against theft but is conveniently removed by the owner when ready to couple the trailer to the authorized towing vehicle.

The present invention relates to a universal trailer coupling lock that secures a trailer hitch receiver coupling to a trailer hitch using a series of coupler-specific adapters. The universal coupler lock contemplated herein comprises: (a) a lock assembly with a cavity that at least partially covers the trailer hitch receiver coupling when said assembly is in a locked position; (b) an adapter shaped to fit into said cavity to make the lock fit a predetermined coupler in a secure manner against unintended decoupling.

A very common trailer coupling is a ball hitch coupler having a recess with a flared lower casing that fits over a metal ball secured to the end of the towing vehicle. Locks that engage such couplings often use a slot to fit around the flared housing. A lock assembly moves from a first, unlocked position to a second, locked position. In a preferred embodiment, the locking assembly moves vertically upwardly. This position allows the lock's opening for the key to remain out of contact with water and other environmental contaminants.

A trailer hitch lock usually fits over the coupler cavity, but it is within the scope of the invention to provide a coupler cavity that is hinged to close around the ball hitch coupler.

A trailer hitch lock according to the invention provides a universal coupler cavity that can be in discrete pieces, e.g., 1-10 interlockable pieces, that are separated when unlocked and that, when in a locked position, engage each other to form one cavity.

The adapter portion of the present lock can be positioned anywhere within the universal cavity to form an internal shape that fits a coupling securely. An adapter according to the invention can be disposed on the top, bottom, or a side of the trailer coupler while said trailer coupler is locked inside the trailer lock assembly. The adapter can be permanently attached, such as by adhesives or welding, or datable, such as with screws. It is even possible that the adapter need not be attached to the outer shell of the lock body. It is important for security, however, that the adapter cannot be removed when the trailer lock is in a locked position.

As shown in the figures, the universal trailer coupling lock according to the invention includes a lock body assembly 1 in a lock chamber 2 of coupling lock 3. Lock body assembly 1 is preferably vertically disposed to extend up when locked and down when unlocked (as shown) but may also be disposed horizontally, if desired.

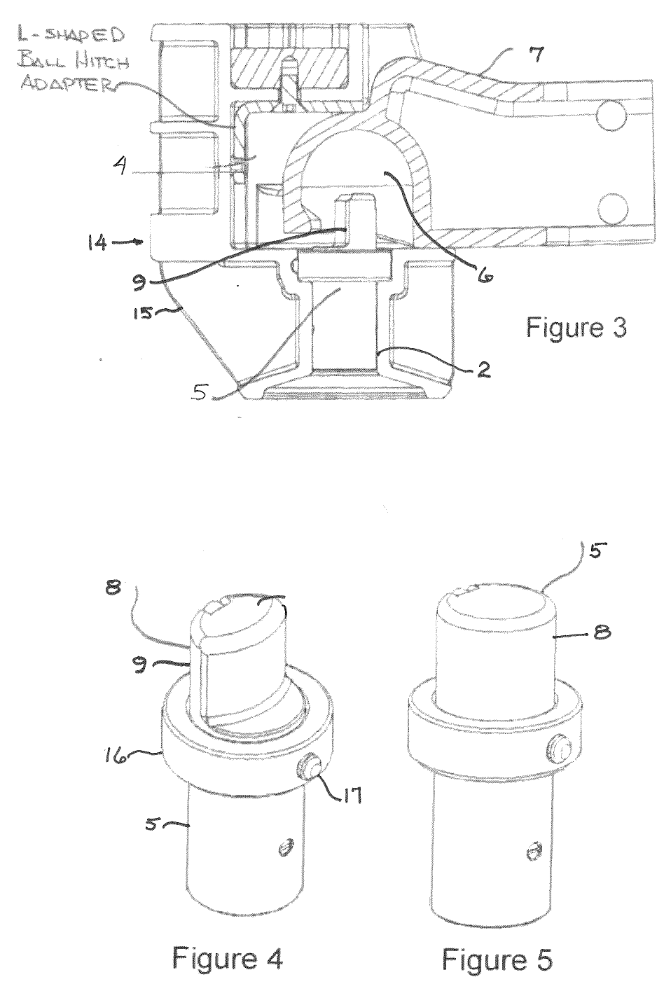

Lock body assembly 1 extends into universal lock cavity 4 so that lock body 5 will enter void region 6 of trailer coupler 7. In the embodiment of FIGS. 3 and 4, lock body 5 has an extension portion 8 of reduced cross-sectional shape 9.

Trailer coupler adapter 10 is secured within universal cavity 4 in a non-removable manner, such as with adapter nut 11 that engages threaded screw 12 extending from adapter 10 through an opening in universal cavity 4. With threaded screw 12, adapter 10 is secured within universal cavity 4. Adapter 10 is shaped to fit within cavity 4 and conform adapted space 13 to fit around coupler 7 in a snug, nonremovable manner while lock body extension 8 is disposed in void region 6.

Adapter nut 11 may be any type of security fastener or security fastener system that is effective at resisting unauthorized removal of the nut once installed. One suitable fastener includes a directional, tamper-resistant nut with a head shape or opening that selectively engages a fastener tool only when operated in a tightening direction. Another type of suitable fastener would use a unique shape for engagement by a unique tool. See, e.g. U.S. Pat. Nos. 1,447,564; 3,874,258; 4,502,825; 4,618,299; 9,004,836 and US patent publication no. 2021/0231162. Yet other types of captive fastener systems use a screw, a tapered bushing, and a slotted expandable sleeve. See U.S. Pat. No. 4,621,961.

A preferred trailer coupler lock shell 14 is a modified version of the lock assembly shown and described in my U.S. Pat. No. 1,176,905 with a plurality of external fins 15 that are designed to deter angle grinder attacks on the lock body. The modification is directed to the formation of a universal cavity 4 in the central region of the lock so that the adapters described herein can be used to fit a wider variety of hitch couplings.

As shown in FIGS. 4 and 5, lock body 5 includes retention ring 16 secured to lock body 5 with set screw 17. Retention ring 16 serves to limit the travel of lock body 5 within lock chamber 2.

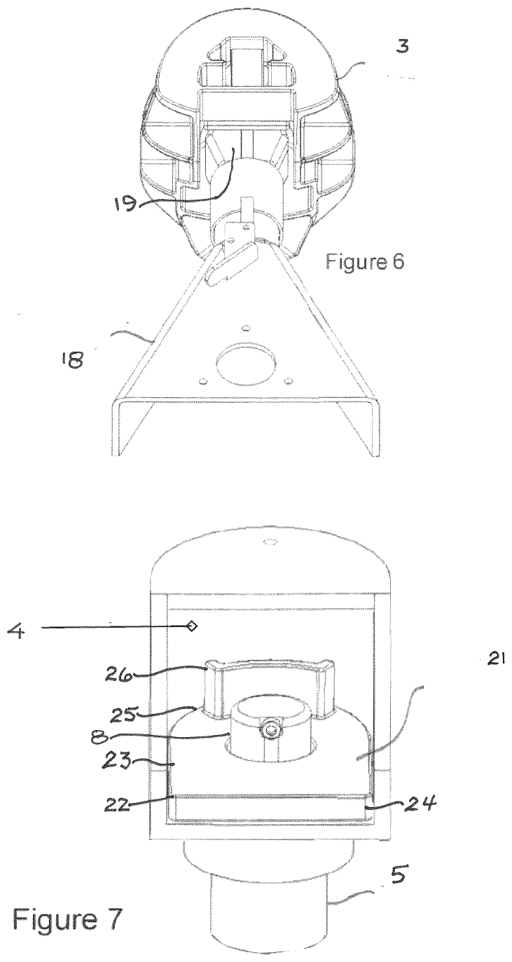

FIG. 6 shows an A-frame sleeve lock coupler 18 (see also FIG. 16) whose coupler end 19 extends through slot 20 into universal cavity 4 and is secured therein by coupling lock 3 of the present invention.

FIGS. 7 and 13 depict a “type A” adapter 21. Type A adapter 21 is substantially planar on its forward side 22 (e.g., the side facing the boat) of coupling lock 3 with a top side 23 having a first thickness 24. Adapter 21 extends to the rearward side 25 (i.e., the truck or vehicle side) of universal cavity 4. Along rearward side 4 is a raised flange 26 that extends above top side 23 for a distance substantially corresponding to the exposed length 26 of the top end of extension portion 8.

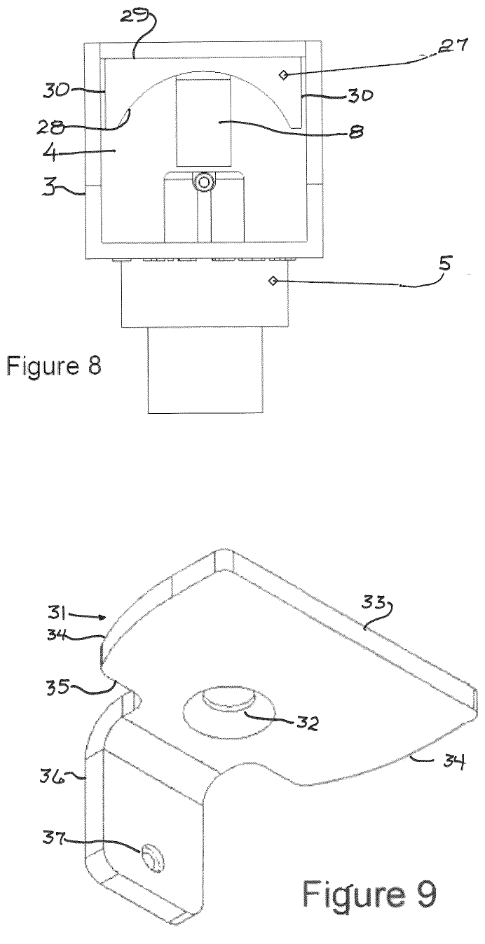

FIG. 8 shows a “Type B” adapter 27 that is concave on lower side 28 and flat on upper side 29 and first lateral sides 30.

FIG. 9 shows a “Type C” adapter 31 configured to fit in universal cavity 4 with a screw through chamfered opening 32. Adapter 31 has a front side 33, second lateral sides 34, and rear side 35 having a downwardly bent flange 36 with securement hole 37.

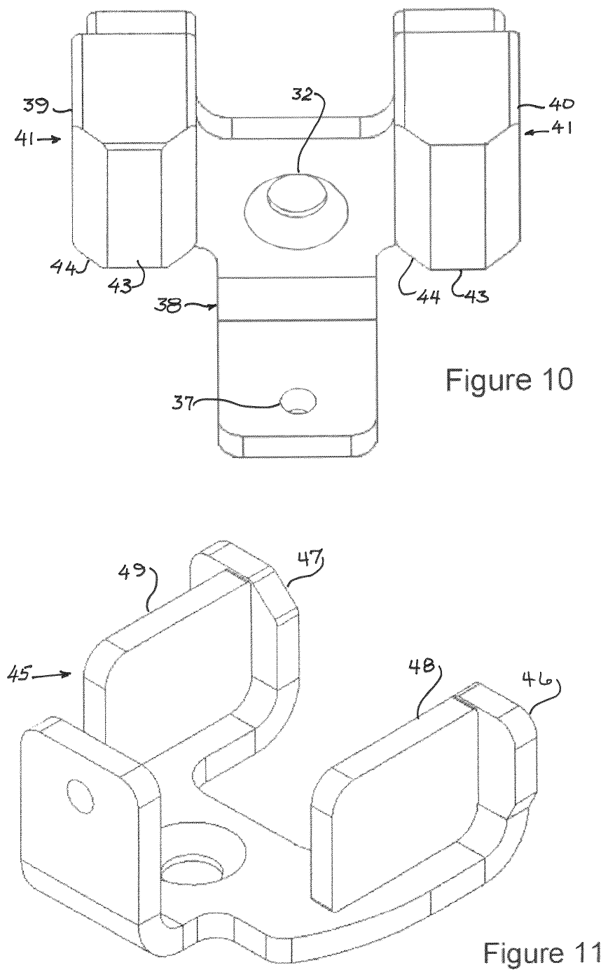

FIG. 10 is a “Type D” adapter 38 similar to that of the Type C adapter (FIG. 9) but with first and second outboard pontoon members 39, 40 on the left and right lateral sides 41, 42. Pontoon members 39, 40 may have front face 43 as well as angled faces 44.

FIG. 11 is a “Type E” adapter 45. The Type E is fundamentally a Type C adapter with first and second front flanges 46, 47 with first and second buttressing vertical walls 48, 49.

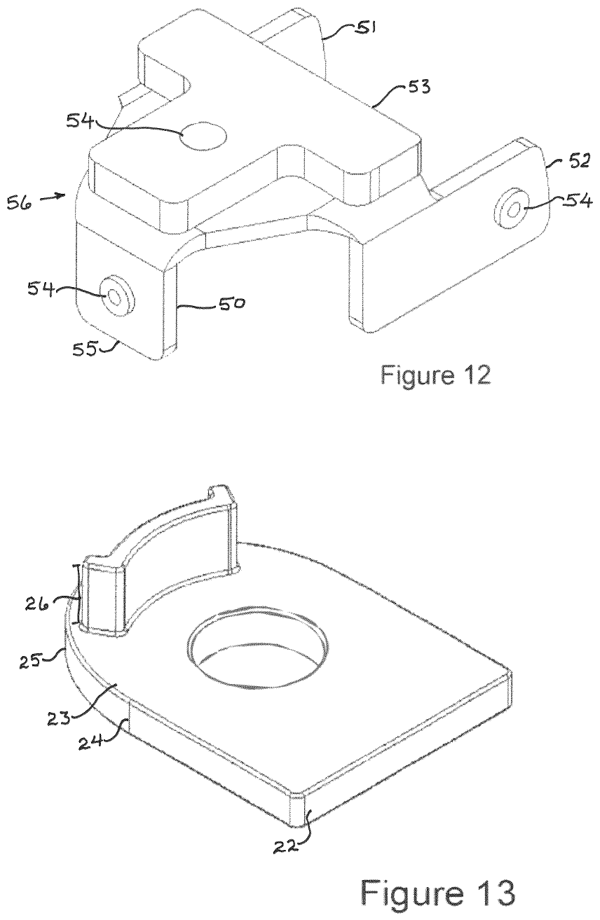

FIG. 12 is a “Type F” adapter 56 that is well-suited for use with A-frame sleeve couplers. This adapter is characterized by a Type C base frame 50 that includes first and second outboard flanges 51, 52 and a thickening plate 53 on top. Openings 54 are provided in each outboard flange 51, 52, back flange 55, and in thickening plate 53 through which screws can be extended to secure this adapter within universal lock cavity 4.

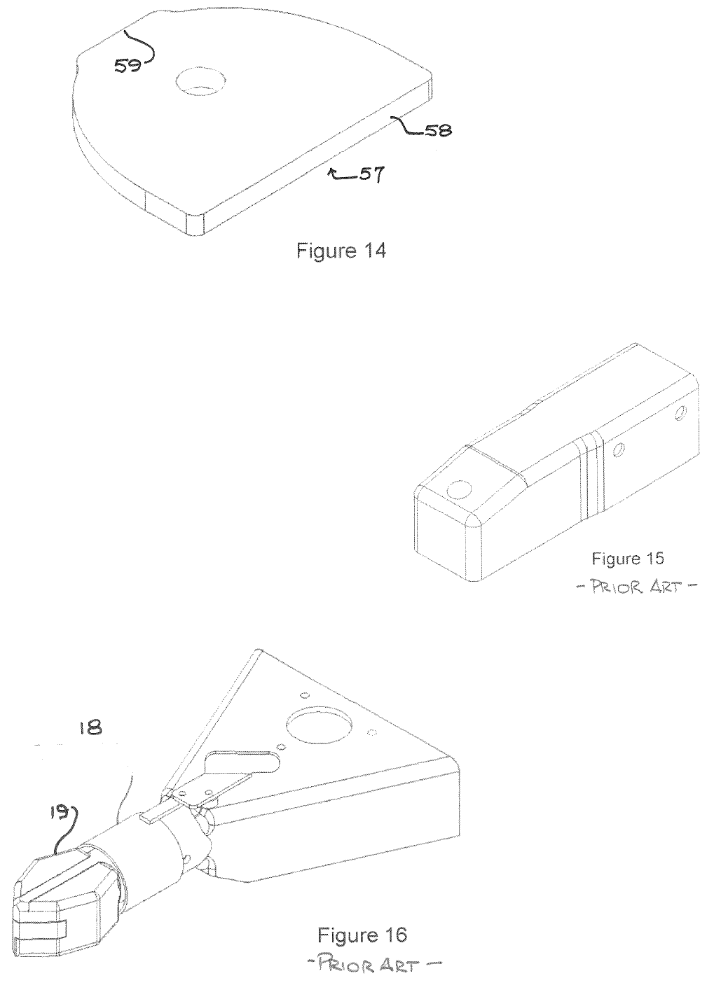

FIG. 14 is a “Type G” plate adapter 57. It is shaped to fit fully within universal lock cavity 4 from plate forward edge 58 to rear plate edge 59.

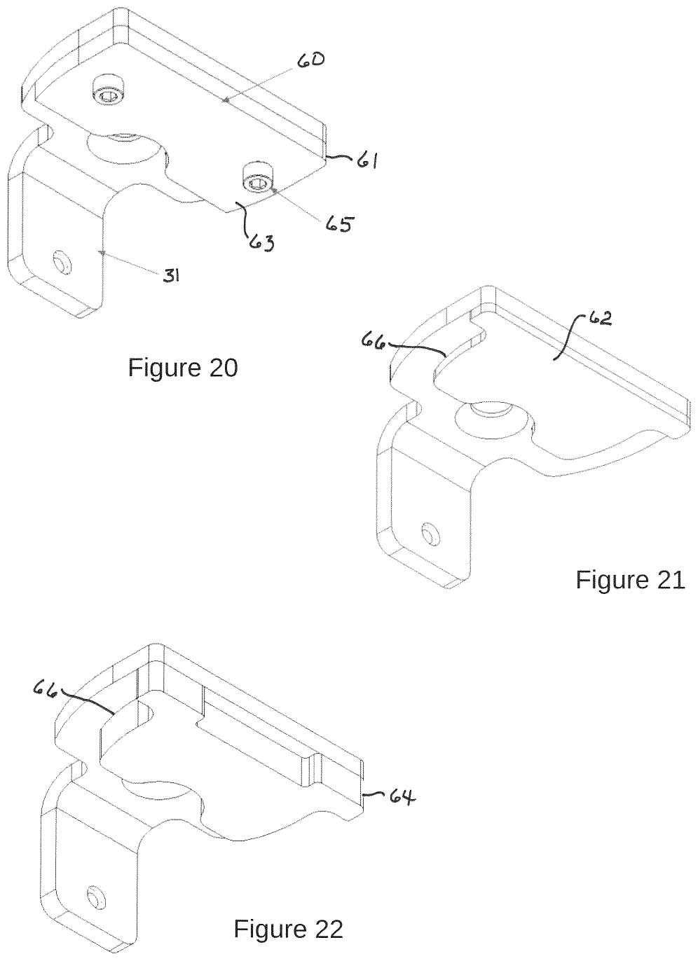

As shown in FIGS. 20-22, the Type C adapter of FIG. 9 can be modified to fit a variety of other couplers by adding sub-adapter plates 60 having various plate thicknesses 61, such as thin sub-adapter plate 62 (FIG. 21, a medium thickness sub-adapter plate 63 (FIG. 20) or a thick sub-adapter plate 64 (FIG. 22). Sub-adapter plates 60 can be attached to the Type C adapter with sub-adapter fasteners 65 (FIG. 20) or by a welded connection 66 between the sub-adapter plate and the Type C adapter (FIGS. 21 and 22).

The disclosures of all cited US patents and published US patent applications are hereby incorporated by reference.

What is claimed is:

1. A trailer hitch lock that secures a trailer hitch receiver coupling to a trailer hitch, said lock comprising: (a) a lock assembly with a cavity that at least partially covers the trailer hitch receiver coupling when said assembly is in a locked position; (b) an adapter shaped to fit into said cavity to make the lock fit a predetermined coupler in a secure manner against unintended decoupling.

2. A trailer hitch lock according to claim 1 wherein the coupler cavity is a slot.

3. A trailer hitch lock according to claim 1 wherein said trailer hitch is a ball hitch coupler.

4. A trailer hitch lock according to claim 3 further comprising a vertical lock body that engages the ball hitch coupler when locked.

5. A trailer hitch lock according to claim 3 wherein the coupler cavity is hinged to close around the ball hitch coupler.

6. A trailer hitch lock according to claim 1 wherein the coupler cavity is formed by separate pieces that are separated when unlocked and that, when in a locked position, engage each other to form one cavity.

7. A trailer hitch lock according to claim 1 wherein the adapter is disposed on the top, bottom, or a side of the trailer coupler while said trailer coupler is locked inside the trailer lock assembly.

8. A trailer hitch lock according to claim 1 wherein said adapter can be detachably fastened into the trailer lock assembly.

9. A trailer hitch lock according to claim 1 wherein said adapter is not fastened into said trailer lock assembly.

10. A trailer hitch lock according to claim 1 wherein said adapter cannot be removed when the trailer lock is in a locked position.

11. A trailer hitch lock according to claim 1 wherein said adapters are made from 1-10 discrete component pieces.
